(19) United States
(12) Patent Application Publication
(10) Pub. No.: US 2019/0245350 A1
(43) Pub. Date: Aug. 8, 2019

(54) Energy Storage System that is Flexibly Connectable In-Front-of-the-meter and Behind-the-meter

(71) Applicants: Shihab Kuran, Watchung, NJ (US); Yazen EL-Harasis, Watchung, NJ (US)

(72) Inventors: Shihab Kuran, Watchung, NJ (US); Yazen EL-Harasis, Watchung, NJ (US)

(21) Appl. No.: 16/268,593

(22) Filed: Feb. 6, 2019

Related U.S. Application Data
(60) Provisional application No. 62/627,289, filed on Feb. 7, 2018.

(51) Int. Cl. H02J 3/32; H02J 13/00; H02J 7/00; H01M 10/48

(52) U.S. Cl. CPC H02J 3/32; H02J 13/0006; H01M 2220/10; H01M 10/482; H02J 7/0013

(57) ABSTRACT

The present invention relates to an in-front and behind the meter connectable electrical energy storage and supply system. The in-front and behind the meter connectable electrical energy storage and supply system comprise of at least one electrical energy storage module, at least one energy conversion module, at least two arrays of switching element, at least one input/output port of in-front-of-the-meter, at least one input/output port of behind-the-meter, at least one monitoring element, at least one controlling element and a communication unit. The energy conversion module receives electricity from either input/output port connected in-front-of-the-meter or from the input/output port connected behind-the-meter. The electrical energy storage module store electricity from the energy conversion module. The input/output port connected in-front-of-the-meter and the input/output port connected behind-the-meter are electrically connected to energy conversion module through switching element array 1. The energy conversion module and the electrical energy storage module are connected through switching element array 2.

### CROSS REFERENCE TO RELATED APPLICATIONS

This patent application claims priority from the earlier filed provisional patent application No. 62/627,289 filed on Feb. 7, 2018.

### FEDERALLY SPONSORED RESEARCH AND DEVELOPMENT

Not applicable.

### MICROFICHE

Not applicable

### (1) FIELD OF THE INVENTION

The present invention generally relates to the field of electrical energy storage, and more particularly the present invention relates to an in-front and behind the meter connectable electrical energy storage and supply system.

### (2) BACKGROUND OF THE INVENTION

Electric power is an essential component of everyday life for billions of people. In the modern world, not a day goes by without many of us using it to power up devices, equipment, electronics and many other things. Electric power for a site (home, school, commercial building etc.) can be generated on site in some cases but is mainly generated elsewhere and transported to the site via an electrical distribution system, referred to as “the distribution network”. The distribution network is typically owned and operated by a utility company. Power generation companies also connect to the distribution network either directly or via transmission lines and other components of the electric grid. Power flows from these generators to the sites that need such power.

When all or some of the site's power for a site is drawn from the distribution network, an electric meter, herein referred to as “the meter”, is needed to measure how much power flows across that boundary to, and possibly from, the site. The meter may be installed on one phase or multiple phases of the electrical interconnection to the source of power (for example, the distribution network). Meters vary in shape, size and functionality. Additionally, the meter can have different measurements for power flowing in either direction (to, or from the site), or may calculate the net result of power by subtracting one of the values from the other. These are referred to as “Net Meters”.

The meter is typically a critical component of the site's interconnection to the electric grid. It may be owned by the utility company that manages the distribution network and is considered to be part of the service equipment. Although, it may physically reside on the site (customer's side), relative to the service point. The “service point” is defined as the connection between the electrical distribution system and the beginning of the site's electrical wiring system. For example, this may be the cable or set of cables that interconnect a house's electrical wiring to a utility company's electric wiring on a nearby utility pole or underground network. Typically, every service point that leads it a customer's site is metered using an electric meter. As mentioned above, this helps measure the flow of power and other useful measurements to know how much power the site consumed from the electric grid or produced to it. This information is typically used for billing the site's owner or operator, by the utility company and other stakeholders. For example, if there are state-sponsored incentives for producing electric power and providing it to the electric grid, it becomes important to know how much power is produced, or at least, how much of that power flowed back to the distribution network.

A number of different types of devices for electric energy storing and distribution are available in prior art. For example, the following patents are provided for their supportive teachings and are all incorporated by reference: Prior art document, US, 2014, 0070756(A1) discloses control methods employed in multiphase distributed energy storage systems that are located behind utility meters typically located at, but not limited to, medium and large commercial and industrial locations. These distributed energy storage systems can operate semi-autonomously, and can be configured to develop energy control solutions for an electric load location based on various data inputs and communicate these energy control solutions to the distributed energy storage systems. In some embodiments, one or more distributed energy storage systems may be used to absorb and/or deliver power to the electric grid in an effort to provide assistance to or correct for power transmission and distribution problems found on the electric grid outside of an electric load location. In some cases, two or more distributed energy storage systems are used to form a controlled and coordinated response to the problems seen on the electric grid.

Another prior art document, U.S. Pat. No. 8,183,714B2 discloses a following idea, i.e. plurality of end-user locations served by a commercial utility grid. More than one and less than all of the end-user locations are themselves interconnected by a feeder, the feeder not metallically connected to the utility grid. The end-user locations each have a local AC bus that is not metallically connected to the utility grid or to the feeder, but that is linked by a coupler to both the utility grid and to the feeder. None of the local AC buses or the feeder is required to have the same phase or frequency as the utility grid. Locally generated electric power may be passed by means of the feeder to other end-user locations that are on the feeder. Each local AC bus has two or more inverters powering the bus.

In addition, prior art document, U.S. Ser. No. 10/132,838B2 discloses interconnection meter socket adapters. An interconnection meter socket adapter comprises a housing enclosing a set of electrical connections. The interconnection meter socket adapter may be configured to be coupled to a standard distribution panel and a standard electric meter, thereby establishing connections between a distribution panel and a user such that electrical power may be delivered to the user while an electrical meter measures the power consumption of the user. A power regulation module is disposed between the interconnection meter socket adapters and configured to selectively connect one or more energy sources or energy sinks.

In addition, prior art document, U.S. Pat. No. 6,687,627B1 discloses a power quality detection, monitoring, reporting, recording and communication in a revenue accuracy electrical power meter. All recorded and computed data is moved to non-volatile storage via direct memory access transfer in the event that a power quality event jeopardizes the operating power of the meter. The meter provides a power supply utilizing high and low capacitive storage banks to supply sufficient energy to survive short duration power quality events which jeopardize the meter's operating power. The power supply also enables the meter to initiate and complete a shut-down routine allowing the storage of he recorded and computed data. Further, a separate power supply utilizing a capacitive storage bank is utilized to operate a communications device when the operating power is lost. The communications device switches from the meter power supply to the alternate capacitive storage bank when a power outage occurs and then initiates a connection with an external network to report the loss of operating power and send the appropriate power management data.

Finally, prior art document, U.S. Pat. No. 6,900,556B2 discloses a large-scale, capacitor-based electrical energy storage and distribution system capable of effectuating load-leveling during periods of peak demand on a utility, and of effectuating a cost savings associated with the purchase of electrical energy. A capacitor or multitude of capacitors may be charged with electrical energy produced by the utility, such as during periods of low demand or low cost and discharged during periods of high electrical energy consumption or high electrical energy cost. One or more capacitors may be located at a consumer's residence or business. Alternatively, a farm of capacitors may be provided at or near a utility, or at or near a location experiencing high demand. In another embodiment, one or more capacitors may be located in or on a vehicle, such as an automobile, a truck, or a train of a light rail system.

However, above mentioned references and many other similar references has one or more of the following shortcomings: (a) connected only one side of the meter; (b) fixed; (c) low power storage capacity; (d) discontinuity in supplying of electricity; and (e) single direction flow of electricity.

The present application addresses the above-mentioned concerns and short comings with regard to providing an in-front and behind the meter connectable electrical energy storage and supply system.

### (3) SUMMARY OF THE INVENTION

In view of the foregoing disadvantages inherent in the known types of energy storage system present in the prior art, the present invention provides an in-front and behind the meter connectable electrical energy storage and supply system for simultaneously supplying both the in front of and behind the meter points and storing electricity. As such, the general purpose of the present invention, which will be described subsequently in greater detail, is to provide an in-front and behind the meter connectable electrical energy storage and supply system which has all the advantages of the prior art and none of the disadvantages.

The main aspect of the present invention is to provide an in-front and behind the meter connectable electrical energy storage and supply system. The in-front and behind the meter connectable electrical energy storage and supply system comprise of at least one electrical energy storage module, at least one energy conversion module, at least two arrays of switching elements, at least one input/output port connected in-front-of-the-meter, at least one input/output port connected behind-the-meter, at least one monitoring element, at least one controlling element and a communication unit. The energy conversion module receives electricity from either input/output port connected in-front-of-the-meter or from the input/output port connected behind-the-meter. The electrical energy storage modules store electricity from either connection. The input/output port connected in-front-of-the-meter and the input/output port connected behind-the-meter are electrically connected to energy conversion modules through an array of switching elements (array 1). The energy conversion module and the electrical energy storage module are connected through a second array of switching elements (array 2).

Another aspect of the present invention is to provide the array of switching elements comprising of switching element array 1 and switching element array 2.

Moreover, another aspect of the present invention electrical energy storage module further comprises of a plurality of battery used for storing and producing electricity.

Moreover, another aspect of the present invention is monitoring the plurality of electrical energy storage module and energy conversion module by the monitoring element.

Moreover, another aspect of the present invention is to provide the controlling element which controls the input/output of electricity from the electrical energy storage system to the input/output connection in-front-of-the-meter and the input/output connection of behind-the-meter.

Moreover, another aspect of the present invention is to provide the communication unit which is further comprise of a GSM module, a wireless module, and a display.

Finally, another aspect of the present invention is to provide energy conversion module converting alternating current (AC) to direct current (DC) and vice versa.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (4) BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 depicts the block diagram of the in-front and behind the meter connectable electrical energy storage and supply system.

FIG. 2 depicts the schematic view of the top view of the electrical energy storage system.

FIG. 3 depicts the schematic view of the side view of the electrical energy storage system.

FIG. 4 depicts the schematic view of the array of switching element of the present invention.

### (5) DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized, and that structural and logical changes may be made without departing from the spirit and scope of the present invention. The following detailed description is, therefore, not to be taken in a limiting sense, and the scope of the present invention is defined by the appended claims and their equivalents.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure and are not meant to be limiting in any fashion.

As used herein, the terms “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition and persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

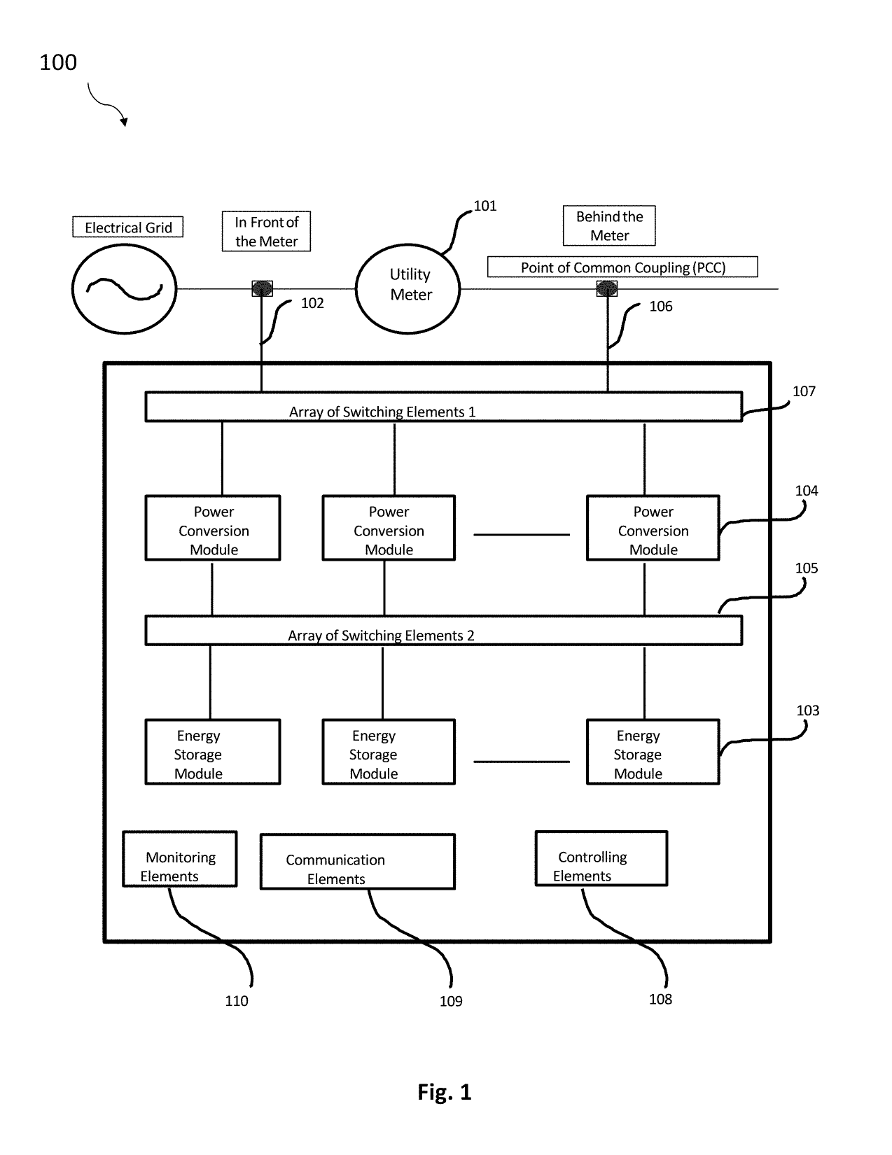

The main embodiment of the present invention is to provide an in-front and behind the meter connectable electrical energy storage and supply system. FIG. 1 shows the block diagram of the in-front and behind the meter connectable electrical energy storage and supply system 100. The in-front and behind the meter connectable electrical energy storage and supply system 100 comprise of at least one electrical energy storage module 103, at least one energy conversion module 104, at least two arrays of switching elements, at least one input/output port connecting in-front-of-the-meter 102, at least one input/output port connecting behind-the-meter 106, at least one monitoring element 110, at least one controlling element 108 and a communication unit 109. The energy conversion module 104 receives electricity from either the input/output port connecting in-front-of-the-meter 102 or from the input/output port connecting behind-the-meter 106. The electrical energy storage module 103 store electricity from the energy conversion module 104. The input/output port connecting in-front-of-the-meter 102 and the input/output port connecting behind-the-meter 106 are electrically connecting to energy conversion module 104 through switching element array 1 107. The energy conversion module 104 and the electrical energy storage module 103 are connected through switching element array 2 105.

The input/output port connecting in-front-of-the-meter 102 in the present invention is the electrical energy storage and supply system's point of interconnection between the electrical grid and the utility meter 101. The electrical grid is the source of power or distribution network of electricity by some agency or organization. And the utility meter 101 is the electric meter that measures the consumption of electricity or optionally may be a net meter. The size, shape and functionality of the utility meter 101 can vary according to the function. The input/output port connecting behind-the-meter 106 is the electrical energy storage and supply system's point of interconnection between the utility meter and the end user site.

The energy conversion module 104 in the present invention converts AC to DC and vice versa. The energy conversion module 104 receives AC electric power from the input/output port connected in-front-of-the-meter 102 through the switching elements array 1. The energy conversion module 104 receives also can receive AC electric power from the input/output port connected behind-the-meter 106. The energy conversion module 104 convert the AC electric power to DC and sends it to the electrical energy storage module 103 through the switching elements array 2. The energy conversion module 104 receives DC power from the electrical energy storage module 103 through the switching elements array 2. The energy conversion module 104 converts the DC power. The converted AC power is then supplied to the input/output port connected behind-the-meter 106 through switching elements array 1. The supplied AC from the input/output port connecting behind-the-meter 106 supplies to the electric circuit of the end user site. The AC power can also be supplied to the input/output port connected in-front-of-the-meter 102 through switching elements array 1. The DC in the present invention is direct current having zero or near to zero phase and zero frequency. The AC in the present invention is the altering current with frequency and near to frequency near to 50 Hz and phase may vary from 0° to 360°.

The plurality of electrical energy storage module 103 and energy conversion module 104 in the present invention are monitored by the monitoring element 110. The monitoring element 110 has a plurality of sensors that measure the amount of total capacity of electricity storage and the amount of total stored electricity in the electrical energy storage module 103. The monitoring element 110 also monitors the health of the electrical energy storage module 103 and other units and modules in the present invention. The monitoring element 110 monitors the availability of electricity from the power grid to the end user site. The monitoring element 110 monitors the total time, remaining time for complete charging and discharging of the electrical energy storage module 103. The monitoring element 110 connects to communication unit 109 and control unit for sharing the monitored information. The connection among the monitoring element 110, communication unit 109 and the control unit can be wireless such as Wi-Fi. Bluetooth, Zigbee, Radar and other means. The connection among the monitoring element 110, communication unit 109 and the control unit may also be through wire.

The controlling element 108 controls the input and output of electricity from the electrical energy storage system to input/output port connected in-front-of-the-meter 102 and to the input/output port connected behind-the-meter 106. When the power grid is unable to deliver electricity, the controlling element 108 initiate or switches ON the draining of electricity from the electrical energy storage module 103 through the array of switching element and energy conversion module 104 to the input/output port connected behind-the-meter 106, and optionally to the in-front-of-the-meter connection. There is a plurality of switching elements in both switching elements arrays 1 and 2. There are of plurality of converters in the energy conversion module 104. There is a plurality of battery cells in the electrical energy storage module 103. The connection between the energy conversion module 104 and the electrical energy storage module 103 are dynamic, i.e. one particular converter of energy converter module can be connected to plurality of electrical energy storage module 103. The connection of particular converter of energy conversion module 104 to the battery of electrical energy storage module 103 are control by the controlling element 108.

The communication unit 109 in the present invention further comprises of a GSM module, a wireless module, and a display. The communication unit 109 connects with monitoring unit and the controlling unit. The connection among the monitoring element 110, communication unit 109 and the control unit can be wireless such as Wi-Fi. Bluetooth, Zigbee, Radar and other means. The connection among the monitoring element 110, communication unit 109 and the control unit may also be through wire connection. The communication unit 109 also connects to the display through the GSM module and wireless module. The display in the present invention may be any visualization device that may attach with the in-front and behind the meter connectable electrical energy storage and supply system 100. The communication unit 109 may connect to user mobile objects and database through the GSM module. The mobile objects may include any mobile, PC, laptop, desktop, tablet, telephone and other objects that can communicate wirelessly and through GSM module. The user may view the details about the in-front and behind the meter connectable electrical energy storage and supply system 100 in the mobile objects display.

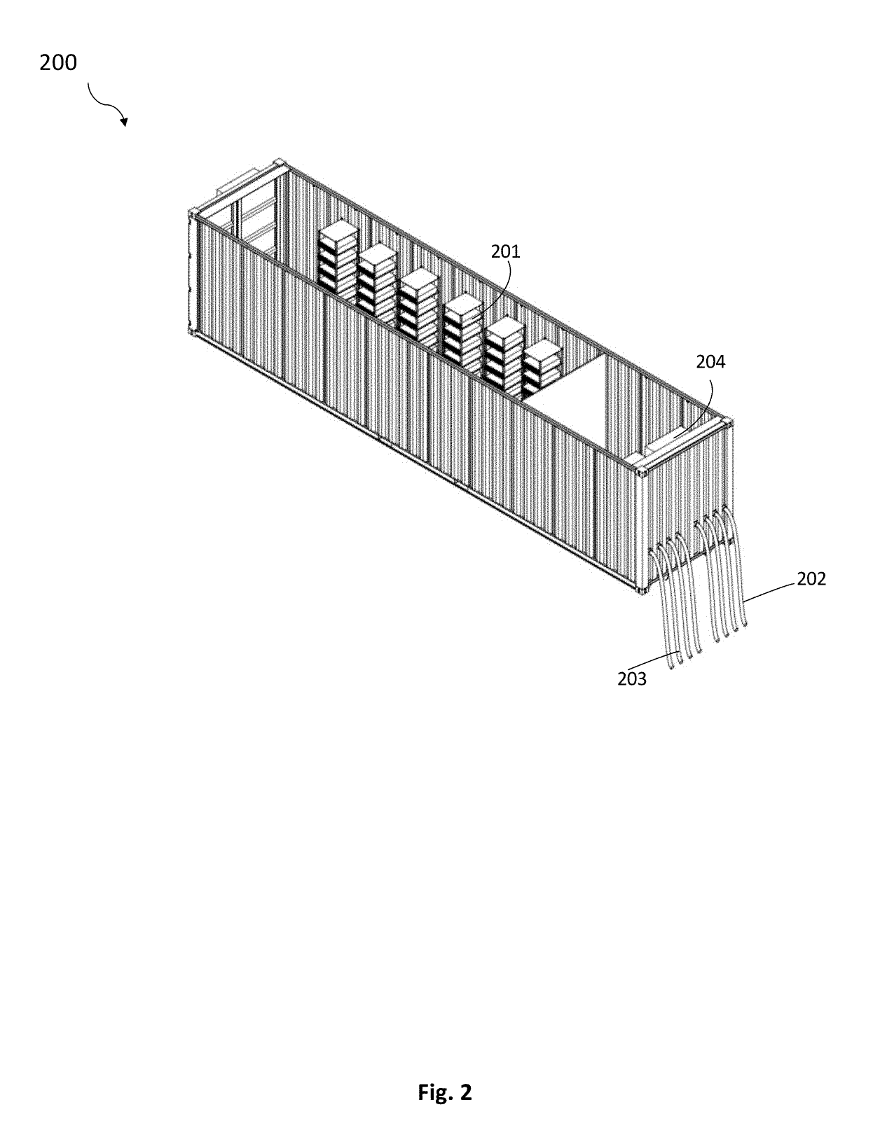

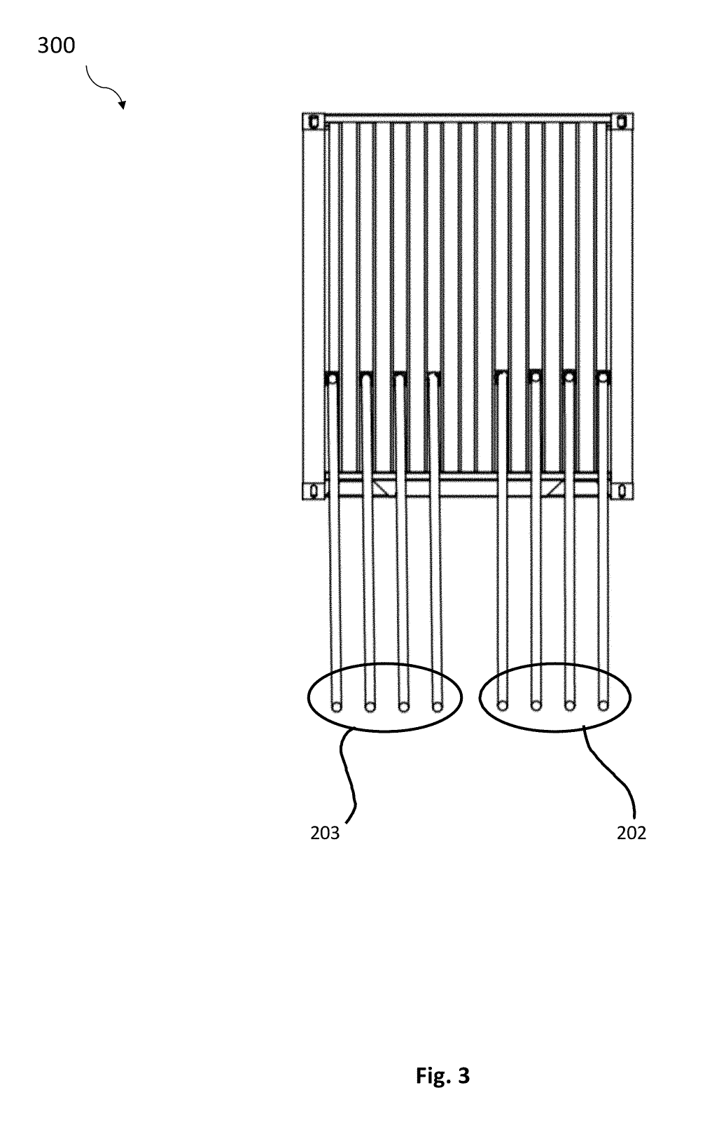

FIG. 2 shows the schematic view of the top view of the electrical energy storage system and the FIG. 3 shows the schematic view of the side view of the electrical energy storage system. The electrical energy storage module 201 further comprise of plurality of battery cells used for storing and releasing electricity. Switching elements array 1 are connected through either the font-of-the-meter or behind-the-meter through two sets of cables such 203 and 202 with one set of cables 203 connected behind-the-meter and 202 connected behind-the-meter. The electrical energy storage module 201 receives electrical energy from the energy conversion module 204.

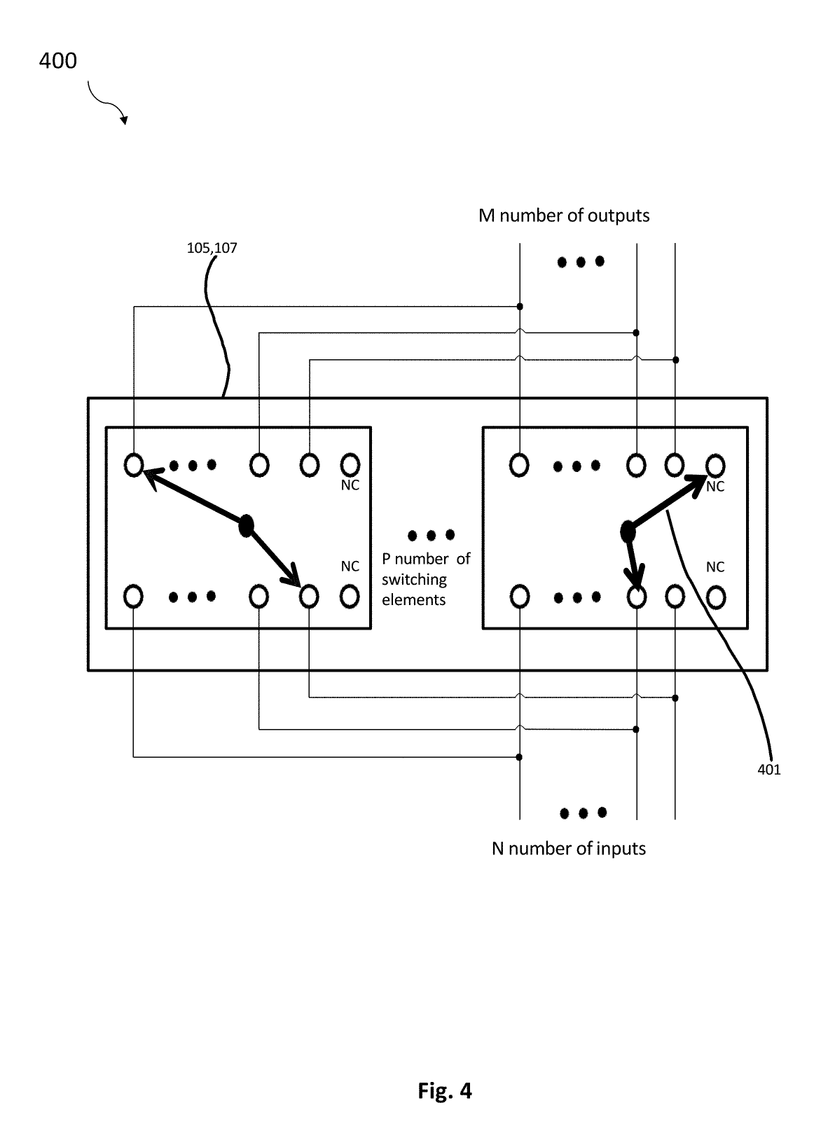

FIG. 4 shows the schematic view of an array of switching elements of the present invention. The switching element has a plurality of input ports, a plurality of output ports and selectors 401. Array of switching elements comprise of P number of switching elements, where P is any integer number equal to zero or more. The selector 401 that can interconnect electrically one of N number of inputs to any of M number of outputs of the switching element and optionally there may be one location on the selector 401 such that there will be no connection between any of the inputs to any of the outputs of the switching element (not connected, or NC). The control of the switching elements is done either manually on site or remotely via the communication unit 109, monitoring and control elements or both. Optionally user can use two back-to-back single-pole-multiple-throw electric switches that combined form the multiple-input-to-multiple-output switch.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I/We claim:

1. An in-front and behind the meter connectable electrical energy storage and supply system 100 comprising:
At least one electrical energy storage module 103, at least one energy conversion module 104, at least two arrays of switching elements, at least one input/output port connected in-front-of-the-meter 102, at least one input/output port connected behind-the-meter 106, at least one monitoring element 110, at least one controlling element 108 and a communication unit 109 and
Wherein said energy conversion module 104 receives electricity from either input/output port connected in-front-of-the-meter 102 or from said input/output port connected behind-the-meter 106, and wherein said electrical energy storage module 103 stores electricity from the energy conversion module 104 and wherein said input/output port connected in-front-of-the-meter 102 and said input/output port connected behind-the-meter 106 is electrically connected to energy conversion module 104 through switching element array 1 107 and wherein said energy conversion module 104, said electrical energy storage module 103 are connected through switching element array 2 105.

2. The in-front and behind the meter connectable electrical energy storage and supply system 100 according to claim 1 wherein said array of switching element further comprise of a switching element array 1 107 and switching element array 2 105.

3. The in-front and behind the meter connectable electrical energy storage and supply system 100 according to claim 1 wherein said electrical energy storage module 103 further comprise of plurality of battery 201 used for storing and producing electricity.

4. The in-front and behind the meter connectable electrical energy storage and supply system 100 according to claim 1 wherein said monitoring element 110 monitors plurality of electrical energy storage module 103 and energy conversion module 104.

5. The in-front and behind the meter connectable electrical energy storage and supply system 100 according to claim 1 wherein said controlling element 108 controls the input and output of electricity from said electrical energy storage system to input/output port connected in-front-of-the-meter 102 and to input/output port connected behind-the-meter 106.

6. The in-front and behind the meter connectable electrical energy storage and supply system 100 according to claim 1 wherein said communication unit 109 further comprise of a GSM module, a wireless module, and a display.

7. The in-front and behind the meter connectable electrical energy storage and supply system 100 according to claim 1 wherein said energy conversion module 104 convert AC to DC and vice versa.
